(19) United States
(12) Patent Application Publication
(10) Pub. No.: US 2008/0163622 A1
(43) Pub. Date: Jul. 10, 2008

(54) Exhaust Gas Turbo Charger For Internal Combustion Engine

(75) Inventors: Martin Schlegl, Rudersberg (DE); Steffen Schmitt, Ditzingen (DE)

Correspondence Address: Davidson, Davidson & Kappel, LLC, 485 7th Avenue, 14th Floor, New York, NY, 10018, US

(73) Assignee: DaimlerChrysler AG, Stuttgart (DE)

(21) Appl. No.: 11/791,248

(22) PCT Filed: Nov. 22, 2005
(86) PCT No.: PCT/EP2005/012470

§ 371 Date: Oct. 22, 2007

(30) Foreign Application Priority Data
Nov. 26, 2004 (DE) 10 2004 057 138.4

(51) Int. Cl. F02B 29/04

(52) U.S. Cl. 60/599

(57) ABSTRACT

In an exhaust gas turbocharger for an internal combustion engine, with a turbine wheel arranged in the exhaust gas stream of the engine and including a heat-resistant light metal alloy, with a compressor wheel arranged in the intake air stream of the engine, with a shaft including steel, the compressor wheel being seated on the shaft and the turbine wheel being connected to the shaft by welding, and with a mounting for the shaft, a hub adapted to the shaft diameter is formed on the turbine wheel, the connection point between the hub of the turbine wheel and the shaft being arranged in the vicinity of the mounting.

The invention relates to an exhaust gas turbocharger for an internal combustion engine according to the preamble of claim 1.

EP 0 513 646 B1 discloses a method for the connection of parts consisting of steel and of an aluminum or titanium alloy, in which, in a first friction welding pass, a nickel lamina or a copper layer is applied to the steel part and a vanadium layer is applied to the titanium part. After the intermediate layers have been worked up mechanically, the parts are connected to one another in a second friction welding pass. The method is complicated because of the number of process steps and the material used for the intermediate layers.

In a method for the friction welding of a steel shaft on a turbine rotor consisting of titanium aluminide according to EP 0 816 007 B1, a heat-resistant alloy is applied to the joining surface of the shaft before friction welding. Friction welding gives rise on the shaft to a cracked surface which is subsequently worked off.

JP 08-281454 A shows the connection of parts consisting of titanium aluminide and of steel by friction welding, using an intermediate material having a low thermal volume change.

In the connecting method according to JP 09-07609 A, a heat-resistant alloy having a central bore is applied by build-up welding to a steel part before friction welding to a part consisting of titanium aluminide. This is intended to avoid errors due to different thermal volume expansions.

WO 92/20487 A1 describes a turbocharger, in which a hub connected to blades and consisting of an aluminum or titanium wrought alloy is friction-welded to a steel shaft, with a transitional layer which consists of a ductile secondary group metal being interposed. In a variant, a fastening component which receives radial sealing rings is used between the shaft and hub. The design is cost-intensive and requires a large amount of material.

The object of the invention is to develop an exhaust gas turbocharger for an internal combustion engine, said exhaust gas turbocharger having a cost-effective construction and exhibiting improved functionality.

The object is achieved by means of an exhaust gas turbocharger which has the features as claimed in claim 1. Advantageous refinements may be gathered from the subclaims.

According to the invention, on a turbine wheel which consists of high-strength light metal alloys, in particular aluminides, a hub is formed which is connected to a steel shaft by welding. The aluminides are preferably a titanium aluminide or iron aluminide. The diameter of the hub is adapted to the diameter of the shaft at the welding point. The welding point is located, in the axial direction, in the vicinity of a bearing point of the shaft.

Preferably, the shaft and the turbine wheel or the hub are connected to one another by friction welding directly, that is to say without the aid of intermediate pieces or intermediate layers. For mounting the turbine wheel or the shaft, two rolling bearings are provided which are spaced axially apart from one another, the weld seam lying between the bearings or on the side of the turbine wheel or on the side of a compressor wheel. The turbine wheel may be produced with a shaft extension by casting, a turbine-side shaft seal being integrated on the shaft extension. For receiving a shaft seal, grooves may be introduced into the extension or into the hub. The bearings may be formed on the shaft extension, the bearing inner rings or raceways being worked directly out of the material of the shaft extension. Furthermore, on the hub, cooling ribs, cooling blades or suchlike cooling elements may be formed, around which a cooling fluid flows in order to cool the shaft.

In a preferred refinement of the invention, the rolling bearings are designed as hybrid or solid ceramic bearings.

The invention affords a series of advantages. The exhaust gas turbocharger possesses low mass and therefore a low moment of inertia, so that the nonstationary behavior is improved. The exhaust gas turbocharger according to the invention has a high thermal and mechanical load-bearing capacity. This results, when an engine is in operation, in a higher possible engine power. On account of the heat-resistant material of the turbine wheel, the engine can operate at higher exhaust gas temperatures, so that the engine has lower pollutant emissions. The introduction of heat into the steel shaft or the mounting is only slight on account of the poor thermal conductivity of the material of the turbine wheel or of the hub or of a work-up shaft extension. In a turbine wheel consisting of titanium aluminide, owing to the high heat resistance and creep resistance, the blade geometry can be varied such that engine efficiency rises. In the connection of a turbine wheel and shaft by direct friction welding, outlay and costs are markedly reduced during the joining operation. If additional functional elements, such as sealing, bearing and cooling elements, are formed on the turbine wheel material having high load-bearing capacity, expenditure for additional parts can be saved.

The invention will be explained in more detail with reference to exemplary embodiments. In the drawing:

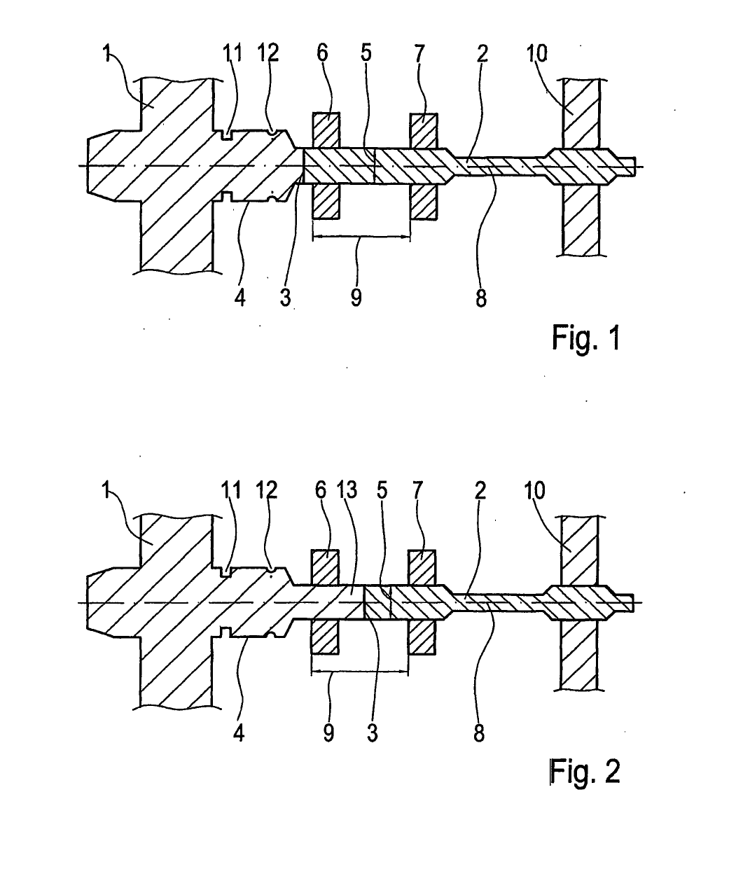

FIG. 1 shows a turbine wheel and shaft of an exhaust gas turbocharger with a turbine-side welding point,

FIG. 2 shows a turbine wheel and shaft of an exhaust gas turbocharger with a welding point between bearing points,

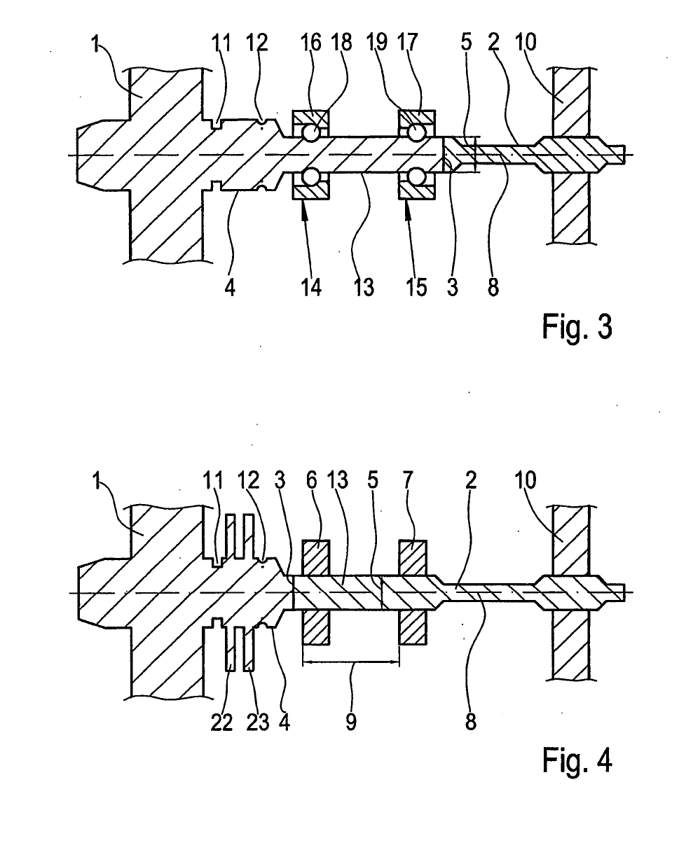

FIG. 3 shows a turbine wheel and shaft of an exhaust gas turbocharger with a compressor-side welding point, and

FIG. 4 shows a turbine wheel and shaft of an exhaust gas turbocharger with a turbine-side welding point and with cooling ribs integrated on the turbine wheel.

FIG. 1 shows a turbine wheel 1 and a shaft 2 of an exhaust gas turbocharger with a turbine-side welding point 3. The turbine wheel 1 consists of a highly heat-resistant light metal alloy, such as titanium aluminide. Blades standing in the exhaust gas stream of an internal combustion engine are located on the turbine wheel 1. A cylindrical hub 4 is formed on the turbine wheel 1. The hub 4 is tapered at the end to the diameter 5 of the shaft 2, so that a small joining cross section is obtained. The shaft 2 consisting of steel is friction-welded at the welding point 3 directly to the hub 4 consisting of titanium/aluminum. The shaft 2 is held radially in two bearings 6, 7. The bearings 6, 7 possess a spacing 9 in the direction of an axis of rotation 8, the bearing 6 being located in the vicinity of the welding point 3. The bearings 6, 7 may be designed as plain or rolling bearings. If the bearings 6, 7 are designed as rolling bearings, they also assume the axial support of the shaft. On the far side of the bearing 7, the shaft 2 is tapered further and at the end carries fixedly in terms of rotation a compressor wheel 10. Grooves 11, 12 for the reception of shaft seals or for working out oil splash grooves are incorporated into the surface area of the cylindrical hub 4. The seals prevent oil leakage and an undesirable routing of the exhaust gas.

Insofar as reference symbols already introduced are used in the following description, these are elements or symbols having an equivalent function or significance.

In the variant according to FIG. 2, a welding point 3 is located between bearings 6, 7. The hub 4 is prolonged by a shaft extension 13. The bearing 3 is arranged on the shaft extension 13 which has the same diameter 5 as the shaft 2. This version otherwise corresponds to the version according to FIG. 1.

In a further variant according to FIG. 3, two ball bearings 14, 15 are formed as hybrid bearings on a shaft extension 13 of a turbine wheel 1 consisting of titanium/aluminum. The ball bearings 14, 15 consist in each case of an outer ring 16, 17, balls 18, 19 and running surfaces 20, 21 on the shaft extension 13. A friction welding point 3 between the shaft extension 13 and a shaft 2 consisting of steel is formed directly next to the ball bearing 15 on the side of a compressor wheel 10. The turbine wheel 1, a worked-up hub 4 and the shaft extension 13 consist of one casting. The shaft extension 13 consisting of titanium/aluminum possesses high strength, so that the running surfaces 20, 21 are subjected to only low wear, and, consequently, these and the entire bearing unit have an increased service life.

A variant according to FIG. 4 corresponds in terms of the arrangement of the welding point to the version according to FIG. 1, cooling ribs 22, 23 being worked up, in addition to grooves 11, 12 for seals, on the hub 4. A cooling fluid, such as air, water or oil, is conducted through between the cooling ribs 22, 23 for the discharge of heat, so that less heat is conducted into the region of the shaft mounting. The cooling fluid is screened off from engine exhaust gases by means of a seal in the groove 11 and from the bearing lubrication oil by means of a seal in the groove 12. Low thermal load on the engine oil and a reduction in oil coking are achieved by virtue of this arrangement. The service life of the bearings 6, 7 is prolonged. It becomes possible to employ novel bearing lubrication methods, such as minimum quantity oil lubrication or lifetime grease lubrication, oil consumption and oil losses being reduced.

The variants according to FIGS. 1-4 are to be seen merely by way of example. The features of the arrangement and design of the bearings 6, 7, 14, 15, of the arrangement of the welding point 3 with respect to the bearings 6, 7, 14, 15, and of the integration of sealing and cooling functions on the side of the turbine wheel 1 may be combined in any desired way.

1-13. (canceled)

14. An exhaust gas turbocharger for an internal combustion engine, comprising:
a turbine wheel arranged in an exhaust gas stream of the engine and including a heat-resistant light metal alloy, the turbine wheel including a hub;
a compressor wheel arranged in an intake air stream of the engine;
a shaft including steel, the compressor wheel being seated on the shaft and the turbine being welded to the shaft; and
a mounting for the shaft;
the hub being adapted to the shaft diameter, a connection point between the hub and the shaft being arranged adjacent to or at the mounting.

15. The exhaust gas turbocharger as recited in claim 14 wherein the hub and the shaft are connected directly by friction welding.

16. The exhaust gas turbocharger as recited in claim 14 wherein the connection point is arranged axially on the turbine side, on the compressor side or between the mounting.

17. The exhaust gas turbocharger as recited in claim 14 wherein the mounting includes two rolling bearings spaced apart from one another axially.

18. The exhaust gas turbocharger as recited in claim 17 wherein the rolling bearings are hybrid or solid ceramic bearings.

19. The exhaust gas turbocharger as recited in claim 14 wherein at least one of the rolling bearings is arranged on a shaft extension of the hub.

20. The exhaust gas turbocharger as recited in claim 19 wherein the at least one of the roller bearings has an inner raceway directly on the shaft extension.

21. The exhaust gas turbocharger as recited in claim 14 wherein the hub includes recesses for at least one seal.

22. The exhaust gas turbocharger as recites in claim 14 further comprising a cooler is provided on the hub.

23. The exhaust gas turbocharger as recited in claim 22 wherein the cooler includes cooling ribs formed on the hub.

24. The exhaust gas turbocharger as recited in claim 23 wherein the cooling ribs are capable of receiving a coolant flow between the cooling ribs.

25. The exhaust gas turbocharger as claimed in claim 23 further comprising seals arranged on both sides of the cooling ribs.

26. The exhaust gas turbocharger as claimed in claim 14 wherein the turbine wheel includes titanium aluminide.

27. The exhaust gas turbocharger as claimed in claim 14 wherein the hub includes titanium aluminide.
